(19) United States
(12) Patent Application Publication
(10) Pub. No.: US 2014/0033844 A1
(43) Pub. Date: Feb. 6, 2014

(54) STEP-VARIABLE TRANSMISSION FOR A MOTOR VEHICLE

(71) Applicant: GETRAG Getriebe- und Zahnradfabrik Hermann Hagenmeyer GmbH & Cie KG, Untergruppenbach (DE)

(72) Inventors: Stefan Rothvoss, Steinheim (DE); Jochen Bausch, Bietigheim (DE); Guenter Ruehle, Loechgau (DE)

(73) Assignee: GETRAG Getriebe- und Zahnradfabrik Hermann Hagenmeyer GmbH & Cie KG, Untergruppenbach (DE)

(21) Appl. No.: 13/956,725

(22) Filed: Aug. 1, 2013

(30) Foreign Application Priority Data
Aug. 6, 2012 (DE) DE102012015863

(51) Int. Cl. F16H 3/16

(52) U.S. Cl. CPC F16H 3/16
USPC 74/335

(57) ABSTRACT

Step-variable transmission for a motor vehicle. The transmission has a gearbox inlet, which can be connected to a drive motor, and has a gearbox outlet, which can be connected to a driven axle of the motor vehicle. The step-variable transmission is designed for establishing at least a first gear and a further gear. Power in the first gear is transmitted from the gearbox inlet to the gearbox outlet by way of a first clutch arrangement. Power in the further gear is transmitted from the gearbox inlet to the gearbox outlet by way of a second clutch arrangement. The second clutch arrangement comprises a powershift clutch. The first clutch arrangement comprises an overrunning clutch.

### CROSS REFERENCE TO RELATED APPLICATIONS

This application claims the priority of German patent application DE 10 2012 015 863, filed Aug. 6, 2012.

### BACKGROUND OF THE INVENTION

The present invention relates to a step-variable transmission for a motor vehicle, having a gearbox inlet, which can be connected to a drive motor, and having a gearbox outlet, which can be connected to a driven axle of a motor vehicle, the step-variable transmission being designed for establishing at least a first gear and a further gear, power in the first gear being transmitted from the gearbox inlet to the gearbox outlet by way of a first clutch arrangement, power in the further gear being transmitted from the gearbox inlet to the gearbox outlet by way of a second clutch arrangement, and the second clutch arrangement comprising a powershift clutch.

The present invention further relates to a method for performing traction upshifts and traction downshifts in such a step-variable transmission, and to a method for operating the step-variable transmission in reverse drive mode.

DE 199 17 724 A1 discloses a step-variable transmission of the aforesaid type.

This document discloses the provision of a drivetrain for an electric or hybrid vehicle, the drivetrain comprising a powershift two-speed gearbox. Here an electric machine is connected by way of a constant gear set to a gearbox input shaft, on which two idler gears are rotatably supported. The idler gears can be connected to the gearbox input shaft by means of powershift friction clutches. A differential is furthermore connected to two driving gears, which mesh directly with the two idler gears. In this way it is possible to provide a compact drivetrain for an electrically propelled motor vehicle. The two gears afford a spread which allows energy-efficient operation both in urban traffic and in inter-urban traffic.

A disadvantage to this drivetrain lies firstly in the use of two relatively large ring gears (driving gears) on the differential, that is to say in terms of the weight, inertia and manufacturing costs. Furthermore, the outlay for providing the powershift facility is relatively large, since two powershift friction clutches have to be provided with associated actuation systems and associated control devices.

### SUMMARY OF THE INVENTION

Accordingly, an object of the invention is to specify an improved step-variable transmission and an improved method for operating such a step-variable transmission, improving the step variable transmission in terms of the weight, inertia and manufacturing costs, and/or reducing the overall outlay for providing a powershift step-variable transmission having at least two gears.

This object is achieved in the aforesaid step-variable transmission in that the first clutch arrangement comprises an overrunning clutch.

In this embodiment it is not necessary to provide a powershift clutch for the first clutch arrangement. Consequently there is no outlay for providing this arrangement and for providing associated actuation systems and control software. For power shifts between the first and the further gear it is therefore only necessary to actuate the one powershift clutch of the second clutch arrangement for this purpose. The overrunning clutch obviates the need for an actuation in which a pressure overlap of two powershift clutches is called for.

This also results in a potential for further savings due to a less critical functional reliability classification and due to the reduced pressure control accuracy requirement demanded of the powershift clutch by virtue of the function of the overrunning clutch.

Moreover, it may be possible to transmit power from the gearbox inlet to the gearbox outlet even without actuation. This primarily means that there is no likelihood of a breakdown, should the actuation system fail (“limp-home” capability).

Here the overrunning clutch is preferably arranged or designed so that a positive torque can be transmitted by way of the overrunning clutch in the first gear (that is to say in forward travel), and that the overrunning clutch opens in the opposite direction of rotation or loading. Consequently, in reverse drive the overrunning clutch is generally not capable of transmitting a torque, so that a reverse drive mode is not readily possible in the first gear.

The invention is further implemented by a method for performing a traction upshift from the first gear into the second gear of such a step-variable transmission, comprising measures for continuously closing the second clutch arrangement, in order to gradually take up the torque, the overrunning clutch transmitting the remainder of the torque at any given time, and for performing a rotational speed adjustment on completion of the torque transfer.

Here, during the rotational speed adjustment, the powershift clutch is operated with some slip before it fully closes.

The step-variable transmission according to the invention furthermore allows a method for performing a traction downshift from the second gear into the first gear, comprising measures for bringing the second clutch arrangement first into a slipping state and then increasing the rotational speed on the gearbox inlet to a target speed of the first gear and reducing the slipping state again, the torque transmitted by the second clutch arrangement then being reduced until the torque is transmitted by the overrunning clutch.

Finally, with the method according to the invention it is possible to engage a reverse drive mode by operating the powershift clutch assigned to the second gear with slip, so that a stress state in the step-variable transmission remains below a predefined threshold.

The object is therefore achieved in full.

In the case of the step-variable transmission according to the invention it is particularly preferred if the overrunning clutch can be locked and/or decoupled from the gearbox outlet by means of an adjustable lockup clutch.

In the first alternative the overrunning clutch is locked by means of the lockup clutch in one shift position, so that torque transmission is possible both in a positive direction and in a negative direction. In this embodiment a reverse drive mode can be engaged by bringing the lockup clutch into this closed position (lockup position). The lockup position can also be engaged when driving in the first gear, in order to relieve the overrunning clutch or to transmit overrun torque.

In the alternative embodiment the lockup clutch allows the overrunning clutch to be decoupled from the gearbox outlet. In this case the lockup clutch can be brought into the decoupling position in order to engage the reverse drive mode. In this case the reverse drive mode can be engaged via the second gear without a stress state occurring in the transmission.

The lockup clutch may be embodied as a positively interlocking clutch or as a friction clutch, for example as a synchronizer clutch.

It is particularly preferred if the lockup clutch is embodied as a dog clutch or as a friction clutch.

Since, in any case, the lockup clutch is usually to be actuated only when a rotational speed adjustment is feasible or has already occurred, costly synchronizing devices for the lockup clutch can preferably be dispensed with. The lockup clutch is therefore cost-effective to manufacture.

It is furthermore advantageous if the lockup clutch is biased by means of a mechanical pretensioning device into an opened position in which the overrunning clutch is not locked, or is biased into a closed position in which the overrunning clutch is coupled to the gearbox outlet.

Where the adjustable lockup clutch serves either to release or rigidly to lock the overrunning clutch, it is preferable if the pretensioning device biases the overrunning clutch into the unlocked state. If, on the other hand, the lockup clutch serves to decouple the overrunning clutch from the gearbox outlet, it is preferable if the pretensioning device biases the lockup clutch, in such a way that the overrunning clutch is coupled to the gearbox outlet.

In other words the pretensioning device it used to shift the lockup clutch into such a position in which the normal function of the overrunning clutch is engaged.

In this embodiment an actuation of the lockup clutch is necessary only in specific operating situations. Consequently in this embodiment it is also possible to simplify the actuation of the lockup clutch.

It is advantageous overall if the powershift clutch can be actuated by means of a first hydraulic actuator, which is directly connected to a pump, the rotational speed of which can be controlled for actuating the powershift clutch.

Such a “pump actuator” allows pressure for actuation of the powershift clutch to be regulated through adjustment of the rotational speed of the pump. One advantage to this is that proportioning valves or the like for adjusting a clutch pressure are not required. The outlay for assembly can therefore be reduced, since more stringent standards for cleanliness during assembly do not need to be imposed.

The first hydraulic actuator can be biased by means of a mechanical pretensioning device into a position in which the powershift clutch is opened. For rapid opening of the clutch it is furthermore preferable if the pump is embodied as a bidirectional pump. In order to close the powershift clutch, the pump here is driven in the one direction of rotation. In order to open the powershift clutch, the pump here is driven in the other direction of rotation.

According to a further preferred embodiment the pump is embodied as a bidirectional pump, the first connection of which is connected to the first hydraulic actuator and the second connection of which is connected to a second hydraulic actuator, which is assigned to the first clutch arrangement.

In this embodiment actuation in the first clutch arrangement can easily ensue by means of the same pressure supply source (pump) which also serves for actuating the powershift clutch of the second clutch arrangement, since in power shifts the overrunning clutch obviates the need for a simultaneous activation of the first and second clutch arrangements.

It is especially preferred here if the second hydraulic actuator is designed for actuating a lockup clutch of the first clutch arrangement.

The lockup clutch, as explained above, may be designed for locking the overrunning clutch or for decoupling the overrunning clutch from the gearbox outlet, and may, if necessary, be mechanically biased into a basic position.

The second hydraulic actuator serves for shifting the lockup clutch into the second position in opposition to the mechanical bias, in order, for example, to engage a reverse drive mode.

It is advantageous overall if the pump can be driven by means of an electric motor in at least one direction of rotation.

In this way the rotational speed and the direction of rotation of the pump can be controlled or regulated through activation of the electric motor.

It is generally advantageous if the pump connection connected to the first hydraulic actuator is connected to a pressure sensor for regulating purposes.

Where a second connection of the pump is connected to a second hydraulic actuator, the second connection may be connected to a further pressure sensor. In an alternative development such a pressure sensor is not necessary, however, since the lockup clutch is in any case only shifted to and fro between two states. A stop sensor or the like may also suffice here to afford security about the position engaged at any given time.

It is especially preferred, however, if the first connection and the second connection of the pump are connected to a single pressure sensor by way of a shuttle valve.

In this embodiment the higher pressure on either of the two pump connections can be registered through the provision of a simple shuttle valve. In the one direction of rotation of the pump this will always be the pressure in the first hydraulic actuator, in the second direction of rotation it will be the pressure in the second hydraulic actuator.

It is furthermore advantageous if yet another gear can be engaged by means of a third clutch arrangement, which comprises a second powershift clutch.

In this embodiment the step-variable transmission can be implemented with three gears. An even more comfortable operation can thereby be achieved. In this embodiment gear changes from the first into one of the further gears and also gear changes between the further gears can in each case be performed under load. In gear changes between the further gears, to each of which a powershift clutch is assigned, gear changes can be performed under load not only as traction shifts but also as overrun shifts.

The highest (third) gear of such a step-variable transmission is preferably assigned to that clutch of the two powershift clutches then provided, which is preferably driven by means of the same pump actuation system as a lockup clutch assigned to the overrunning clutch. In this case the second gear is preferably actuated by means of its own pump actuator arrangement, which comprises a second pump and preferably a second electric motor, which drives the second pump, the clutch pressure adjustment being achieved through adjustment of the rotational speed of the second pump. That gear having its “own” pump actuation system assigned to it, is preferably an intermediate gear.

A gearbox outlet of the step-variable transmission is preferably connected by way of a single drive assembly to a differential of the driven axle, so that the drivetrain can be provided with a lower weight for reduced manufacturing costs. Here the gear wheels of this drive assembly may be helically toothed. In this case it is preferable if a pressure pad arrangement absorbs the axial forces that are generated by the helical toothing.

A parking-mechanism gear, which serves for setting the drive train and the motor vehicle into a parked position, can furthermore preferably be fixed to a gearbox output shaft.

The driven axle may be arranged with offset parallel to a drive shaft of the drive motor, but may also be arranged coaxially with the drive shaft. In the latter case the drive shaft of the drive motor is preferably embodied as a hollow shaft, through which at least one output shaft of the driven axle is led.

Overall, it is possible, depending on the embodiment of the step-variable transmission described above, to achieve a more cost-effective actuation concept compared to the prior art. For example, it is possible to dispense with a powershift clutch for the first gear. In particular there is no need to provide a separately actuated pressure control actuator for this purpose, so that a separate pressure supply, a separate pressure sensor and possibly a separate pump with an electric motor coupled to it are not necessary. There is no need, either, for an additional output stage in the control unit.

The control unit architecture can be simplified in that the proposed step-variable transmission can be of simpler construction due to the less critical functional reliability classification of the control device architecture. Power shifts are also easier to control or regulate due to the overrunning function of the overrunning clutch. In particular reduced pressure control accuracy requirements can be set for actuation of the powershift clutch of the second clutch arrangement.

It will be obvious that the features specified above and those yet to be explained below can be employed not only in the particular combination specified, but also in other combinations or in isolation, without departing from the scope of the present invention.

### DESCRIPTION OF THE SEVERAL VIEWS OF THE DRAWING

Exemplary embodiments of the invention are represented in the drawing and are explained in more detail in the following description. In the drawing:

FIG. 1 shows a schematic representation of a drivetrain of a motor vehicle having a first embodiment of a step-variable transmission according to the invention;

FIG. 2 shows a schematic view of a further embodiment of a drivetrain having a further embodiment of a step-variable transmission according to the invention;

FIG. 3 shows a schematic view of a further drivetrain having a further embodiment of a step-variable transmission according to the invention; and

FIG. 4 shows a schematic view of a further drivetrain having a further embodiment of a step-variable transmission according to the invention;

### DETAILED DESCRIPTION OF PREFERRED EMBODIMENTS

In FIG. 1 a first embodiment of a drivetrain for a motor vehicle is represented schematically and denoted generally by 10. The drivetrain 10 comprises a drive motor 12, which may be embodied as an internal combustion engine, but may be embodied, in particular, as an electric motor (electric machine). The drivetrain 10 further comprises a step-variable transmission 14 having a first gear 1 and a second gear 2, and a driven axle 16. The driven axle 16 comprises a differential 18, which is connected to a gearbox outlet and which is designed to distribute propulsive power to two driven wheels 20L, 20R of the motor vehicle.

The drivetrain 10 serves to drive a driven axle. It will be obvious that power can also be branched off in order to drive a second driven axle. It is furthermore possible to assign the drivetrain to one axle of a motor vehicle and to drive the other axle by means of a conventional drivetrain with internal combustion engine.

The drive motor 12, which is preferably embodied as an electric machine, allows the motor vehicle to be driven purely by electrical means. Here the drive may ensue in the first gear 1, which may preferably be designed for starting and for driving at low speeds (urban operation). The second gear serves, in particular, for engaging propulsive power in interurban operation.

Here, in some operating modes, energy can also be recovered during overrun conditions.

The step-variable transmission 14 comprises a gearbox input shaft 24, which is preferably rigidly connected to a motor shaft of the drive motor 12. The step-variable transmission 14 further comprises a gearbox output shaft 26, which is arranged parallel to the gearbox input shaft 24. The gearbox output shaft 26 is connected by way of an output gear wheel set 28 (“final drive”) to an inlet element of the differential 18.

A first gear wheel set 32 is provided for establishing the first gear. A second gear wheel set 34 is provided for establishing the second gear. The first gear wheel set 32 comprises a first fixed gear wheel 36, which is connected to the gearbox input shaft 24. The first gear wheel set 32 further comprises a first idler gear wheel 38, which is supported on the gearbox output shaft 26 and meshes with the first fixed gear wheel 36. Here, in the first gear 1, power is transmitted from the gearbox inlet 24 to the gearbox outlet 26 by way of a first clutch arrangement 40, which comprises an overrunning one-way clutch 42. The first idler gear wheel 38 here is supported by way of an overrunning (one-way) clutch 42 on the gearbox output shaft 26. The overrunning clutch 42 is designed to transmit positive propulsive power (in forward drive) from the gearbox input shaft 24 to the gearbox output shaft 26. In the opposite direction of rotation, however, no torque can be transmitted via the overrunning clutch 42, so that a reverse drive mode via the overrunning clutch 42 is not possible.

The second gear wheel set 34 comprises a second fixed gear wheel 46, which is fixedly connected to the gearbox input shaft 24. The second gear wheel set 34 further comprises a second idler gear wheel 48, which is rotatably supported on the gearbox output shaft 26. A second clutch arrangement 50, which here comprises a powershift clutch 52, is furthermore assigned to the second gear wheel set 34. The powershift clutch 52 may be embodied as a wet multi-disk clutch, for example, and may serve to connect the second idler gear wheel 48 to the gearbox output shaft 26. Here the powershift clutch 52 can be actuated in such a way that the powershift clutch 52 can be operated either opened or closed, or in a slipping state.

For engaging a reverse drive mode, therefore, the powershift clutch 52 can be operated with slip so that a small torque can be transmitted in the reverse direction. Here the slipping operating mode of the powershift clutch 52 is preferably selected so that a stress state in the step-variable transmission 14 remains below a predefined threshold.

In an optional development of the step-variable transmission 14 a lockup clutch 54 is provided, which is designed to decouple the overrunning clutch 42 from the gearbox output shaft 26. Where such a lockup clutch is provided, a reverse drive mode can be engaged by shifting this lockup clutch so that the overrunning clutch 42 is decoupled from the gearbox outlet 26. In this case a reverse drive mode can be engaged by closing the powershift clutch 52.

A hydraulic actuator arrangement 60 is furthermore assigned to the step-variable transmission 14. The actuator arrangement 60 comprises a first piston/cylinder arrangement 62. The first piston cylinder arrangement 62 is designed to actuate the powershift clutch 52. The first piston/cylinder arrangement 62 preferably comprises a single connection. The first piston/cylinder arrangement 62 may further comprise a return spring, which serves to bias the first piston/cylinder arrangement 62 into a position in which the powershift clutch 52 is opened. A return spring may also be integrated into the powershift clutch.

The actuator arrangement 60 further comprises a hydraulic pump 66, which is driven by an electric motor 68. Here the pump 66 is preferably a bidirectional pump, the directions of rotation of which are indicated schematically by 70 in FIG. 1.

The actuator arrangement further comprises a fluid sump 72.

The pump 66 comprises a first pump connection 74, which is directly connected to the connection of the first piston/cylinder arrangement 62. The pump 66 further comprises a second pump connection 76, which in this case is connected to the fluid sump 72. The first pump connection 74 is further connected to a pressure sensor 78.

For actuating the powershift clutch 52 the pump 66 is set in rotation so that fluid is drawn out of the fluid sump 72 and delivered into the first pump connection 74 and consequently into the first piston/cylinder arrangement 62. The fluid pressure thereby occurring in the first piston/cylinder arrangement 62 is measured by means of the pressure sensor 78. This measured variable can be used to regulate the pressure of the fluid in the first piston/cylinder arrangement 62, by regulating the speed of the electric motor 68. Here the powershift clutch 52 may be actuated in opposition to the action of the first return spring 64.

To open the powershift clutch 52 the electric motor 68 is either shut off, so that the powershift clutch 52 is opened by means of the first return spring 64, for example. Alternatively or in addition to this the pump 66 can also be operated in the opposite direction of rotation, in order to suck fluid rapidly out of the first piston/cylinder arrangement 62 to the fluid sump 72.

The actuating directions of the powershift clutch 52 are shown schematically by 80 in FIG. 1.

FIG. 1 furthermore schematically shows that, where provided, the lockup clutch 54 can also be actuated. Here the actuator arrangement 60 is suitably expanded (see below). Furthermore, the lockup clutch may also be actuated by other means.

It goes without saying that the powershift clutch 52 can also be actuated by another actuation system, for example one of electromechanical type.

The actuation of the optional lockup clutch 54 is shown by 82 in FIG. 1.

The following operating modes are possible with the step-variable transmission 14 in FIG. 1; firstly, driving in first gear. Here the powershift clutch 52 is opened. The overrunning clutch 42 transmits torque in traction. Where the lockup clutch 54 is provided, this is closed. When driving in first gear a transmission of torque is not possible in overrun conditions. Alternatively it is possible to shift into the second gear for this purpose.

When driving in the second gear the powershift clutch 52 is closed, the overrunning clutch 42 is run over. There is no restriction to the transmission of torque in overrun conditions and in traction conditions. The lockup clutch 54 may, if necessary, be closed.

If the lockup clutch 54 is not provided, driving in reverse gear is only possible by driving the drive motor in the opposite direction of rotation and operating the powershift clutch 52 with slip, but only in such a way that a stress state remains below a predefined threshold. If the lockup clutch 54 is provided, this can be opened. In this case a reverse drive mode is also possible with the powershift clutch 52 in the closed state.

Coasting/sailing is also possible. Here the powershift clutch 52 is opened, and in forward driving the overrun clutch 42 may be run over, so that the drive motor 12 does not also turn. In reverse driving the overrun clutch 42 locks and the drive motor 12 is turned if the vehicle is to roll in reverse. Here the drive motor 12 may be operated as a generator, in which case electrical braking ensues.

When shifting from the first gear into the second gear under traction, torque is transferred by continuously closing the powershift clutch 52, so that it takes over and preferably ramps up the torque. At the same time the overrunning clutch 42 automatically transmits the remainder of the torque at any given time.

Following the transfer of torque to the powershift clutch 52, the rotational speed adjustment is performed, that is to say the rotational speed of the drive motor 12 is reduced to the target speed of the second gear. For this purpose either the torque to the still slipping powershift clutch 52 is increased further (“ramped up”), or a torque intervention on the drive motor 12 is performed. As soon as the rotational speed of the drive motor 12 falls, the overrunning clutch 42 is run over and opens.

A downshift from the second gear into the first gear under traction is possible. Starting from a closed powershift clutch 52 and with the overrunning clutch 42 run over, a rotational speed adjustment is performed by reducing the pressure on the powershift clutch 52, in order to bring this into a slipping state. Here the drive motor 12 revs up to a target speed for the first gear, whilst the relative speed on the overrunning clutch 42 continuously diminishes.

As soon as the relative speed on the overrunning clutch 42 has fallen fully, the pressure and hence the torque of the powershift clutch 52 to be transmitted can be reduced; the remainder of the torque is then automatically transmitted by the overrunning clutch 42.

Overrun shifts under load are generally not possible without further measures due to the overrunning clutch 42.

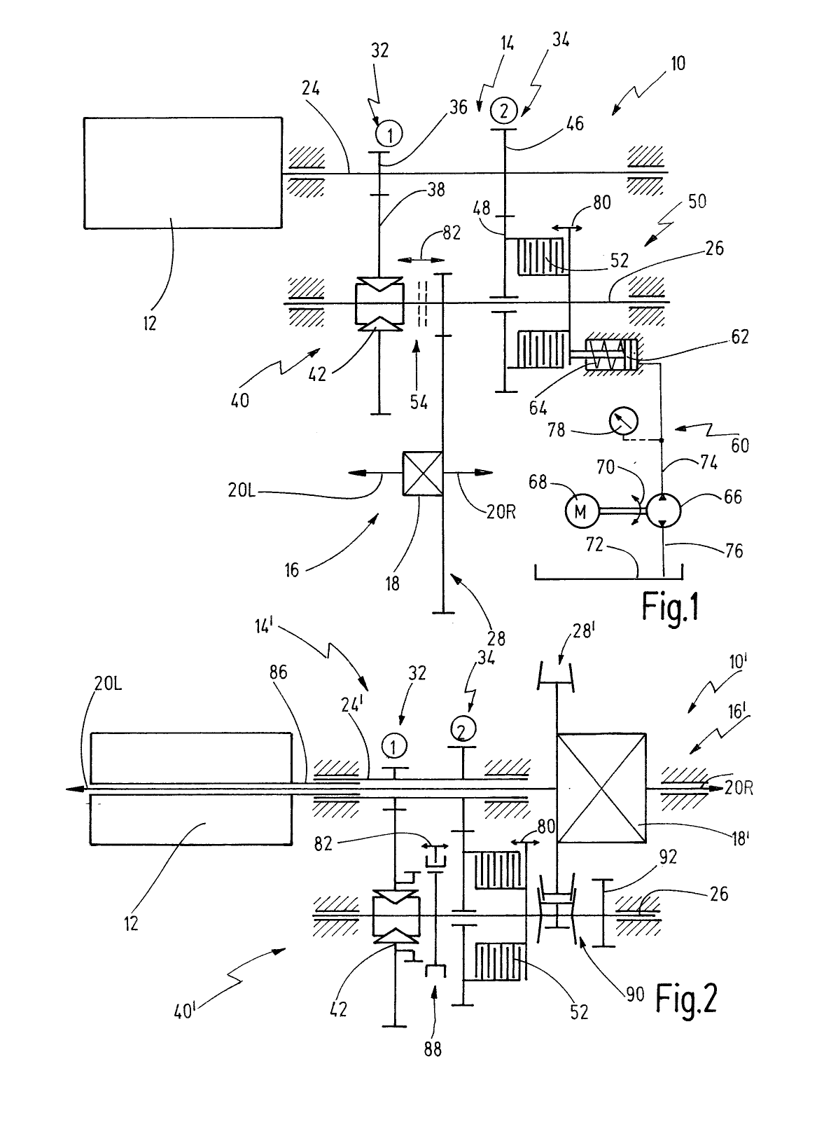

FIG. 2 represents a further embodiment of a drivetrain 10′, which in terms of its construction and operating principle corresponds generally to the drivetrain 10 in FIG. 1. The same elements are therefore identified by the same reference numerals. It is mainly the differences which are explained below.

In the case of the drivetrain 10′ the drive motor 12 is arranged coaxially with the power axle 16′. In this embodiment a motor output shaft 86 is embodied as a hollow shaft, and one of the two output shafts for the driven wheels 20L, 20R is led through the motor output shaft 86.

In this case the gearbox input shaft 24′ is also designed as a hollow shaft. Here the motor output shaft 86 is introduced into the gearbox input shaft 24′ where it is rotationally fixed to the latter. The connection is shown in the area of the gearbox inlet in FIG. 2. In order to allow the motor output shaft 86 to flex more, the connection between the motor output shaft 86 and the gearbox input shaft 24′ may also be arranged, however, at the opposite axial end of the step-variable transmission 14′ to the drive motor 12.

Instead of a lockup clutch 54 in the step-variable transmission 14′, the first clutch arrangement 40 comprises a lockup clutch 88, which in a shift position is designed to lock the overrunning clutch 42, that is to say to connect the gearbox output shaft 26 so that it is rotationally fixed to the idler gear wheel 38 of the first gear wheel set 32.

Here the lockup clutch 88 may be embodied as a dog clutch. The lockup clutch 88 may furthermore be capable of actuation in the same way as the lockup clutch 54 in the embodiment in FIG. 1.

In particular, the lockup clutch may be biased by means of a mechanical pretensioning device into an opened position in which the overrunning clutch 42 is not locked.

In this embodiment a reverse drive mode can be engaged by closing the lockup clutch 88 and opening the powershift clutch 52. Here propulsive power can be transmitted in a negative direction (reverse drive) by reversing the direction of rotation of the drive motor 12.

When driving in the first gear 1 the lockup clutch 88 can be closed in order to relieve the overrunning clutch 42. In this embodiment, when driving in the first gear a transmission of torque is possible under overrun conditions. For coasting/sailing the lockup clutch 88 must be opened.

FIG. 2 furthermore shows that the output gear set 28′ may be designed with a pressure pad arrangement 90, so as to be able to introduce axial forces occurring in the meshing tooth engagement (in the case of helical toothing) directly into the associated shaft (in this case the gearbox output shaft 26).

FIG. 2 furthermore shows that a parking-mechanism gear 92 for engaging a parking lock function can be fixed to the gearbox output shaft 26.

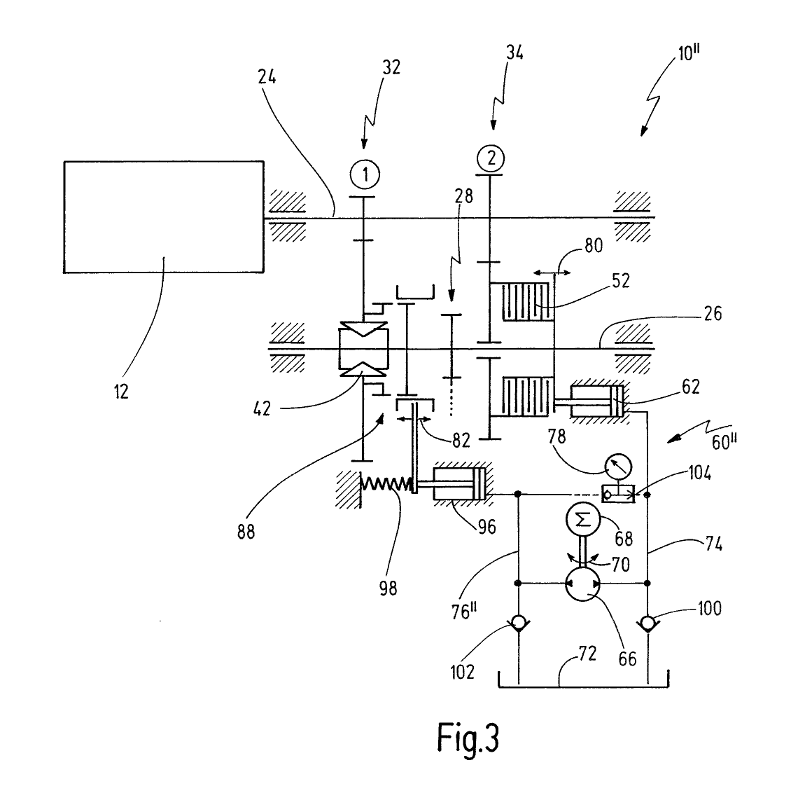

FIG. 3 shows a further embodiment of a drivetrain 10″, the basic layout of which corresponds to the drivetrain 10 in FIG. 1. The same elements are therefore identified by the same reference numerals. It is mainly the differences which are explained below.

Firstly, in the case of the drivetrain 10′ a lockup clutch 88 is assigned to the overrunning clutch 42, as is done in the case of the drivetrain 10 in FIG. 2, and no lockup clutch 54 of the type shown in FIG. 1. Furthermore, the actuator arrangement 60″ is designed so that it can be used not only to actuate the powershift clutch 52, but also for actuation of the lockup clutch 88.

For this purpose a second piston/cylinder arrangement 96 is provided, which by means of a second return spring 98 is biased into an opened position in which the lockup clutch 88 is opened, that is to say the overrunning clutch 42 fulfils its normal function.

The second piston/cylinder arrangement 96 also comprises a single connection. In this case this is connected to the second pump connection 76″. By reversing the direction of rotation of the electric motor 68 a fluid volumetric flow is consequently fed either into the first piston/cylinder arrangement 62 or into the second piston/cylinder arrangement 96.

Here, furthermore, a non-return valve arrangement having a first non-return valve 100 and a second non-return valve 102 is provided. The first non-return valve 100 connects the first pump connection 74 to the fluid sump 72. The second non-return valve 102 connects the second pump connection 76″ to the fluid sump 72. It can consequently be ensured that fluid can be delivered from the fluid sump 72 when delivering fluid in both directions of rotation.

For actuating the powershift clutch 52 the pump 66 is therefore driven by means of the motor 68. If the lockup clutch 88 is to be closed, which is the case only when the powershift clutch 52 is opened, the direction of rotation 70 of the pump 66 is reversed, and fluid is delivered from the fluid sump 72 via the first non-return valve 100 into the second pump connection 76″ and consequently into the second piston/cylinder arrangement 96.

A pressure sensor on the second pump connection 76″ is not absolutely necessary. The pressure on the second pump connection 76″ does not have to be sensitively regulated, since the lockup clutch 88 is preferably embodied as a dog clutch, which is either closed or opened, that is to say it cannot assume a slipping state.

As an alternative to this, however, a single pressure sensor 78 may be used, via a shuttle valve 104, both for registering the pressure on the first pump connection 74 and on the second pump connection 76″. Here the shuttle valve 104 connects the pump connections 74′, 76″. The shuttle valve 104 ensures that it is the higher pressure in either of the pump connections 74, 76″ which is measured.

Basically no additional components are required for actuation of the lockup clutch 88.

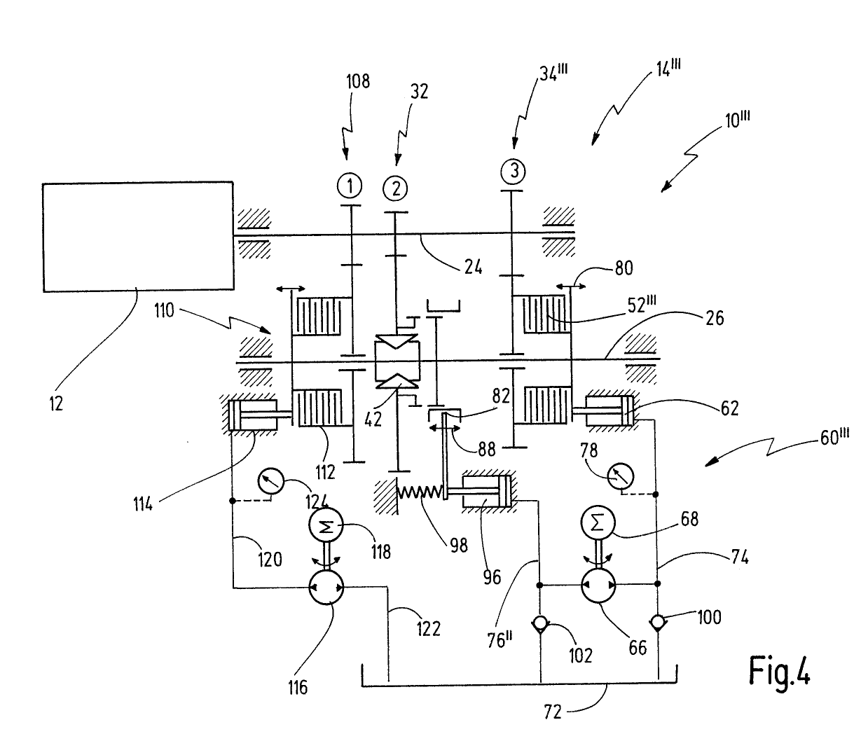

FIG. 4 shows a further embodiment of a drivetrain 10″, the basic layout and the basic operating principle of which correspond to the drivetrain 10″ in FIG. 3. The same elements are therefore identified by the same reference numerals. It is mainly the differences which are explained below.

In the step-variable transmission 14′″ of the drivetrain 10′″ it is possible to engage not two gears, as in the embodiments described, but three gears. Here the construction for engaging the first gear by means of the first gear set 32 and the overrunning clutch 42 is of identical design to the drivetrain 10″ in FIG. 3. Furthermore, for engaging the highest (third) gear a second gear wheel set 34′″ is provided. The second gear wheel set 34′″ is shifted by means of a first powershift clutch 52′″. The actuator arrangement 60′″ for actuating the lockup clutch 88 and the first powershift clutch 52′″ is of identical construction to the embodiment in FIG. 3, with the exception that the pressure sensor 78 is connected solely to the first pump connection 74. Here no pressure sensor is connected to the second pump connection 76″.

For engaging the further gear, which in this case is embodied as the second gear, a third gear wheel set 108 is provided. The third gear wheel set 108 may alternatively also be provided for engaging the highest gear. In this case the second gear wheel set 34′″ is intended for engaging the second gear.

The third gear wheel set 108 can be shifted by means of a third clutch arrangement 110, which comprises a second powershift clutch 112. The basic construction of the second powershift clutch 112 and its actuation by means of a third piston/cylinder arrangement 114 is generally identical to the first powershift clutch 52′″.

In this embodiment the gear wheel sets 108, 32, 34′″ are preferably arranged in this order in an axial direction between the two powershift clutches 52′″, 112.

For actuating the second powershift clutch 112 a further pump actuation system is provided, which comprises a second pump 116. The second pump 116 is preferably embodied as a bi-directional pump and can be driven by means of a second electric motor 118. The second pump 116 comprises a first pump connection 120, which is directly connected to the third piston/cylinder arrangement 114. The second pump 116 further comprises a second pump connection 122, which is connected to the fluid sump 72. A second pressure sensor 124 is connected to the first pump connection 120.

The first pump 66 and the second pump 116 can be actuated independently of one another, so that gear changes between the gears 2 and 3 can be performed under load without any interruption of torque, that is to say with a pressure overlap. For this purpose separate pressure sensors 78, 124 are also provided for the first pump connection 74 of the first pump 66 and the first pump connection 120 of the second pump 116.

The gearbox output shaft 26 may be connected, as in the embodiments in FIGS. 1 and 3, via an output gear wheel set 28 to a differential 18, the differential 18 being assigned to a power axle 16, which is arranged offset parallel to the shafts 24, 26 of the step-variable transmission 14′″. Alternatively it is also possible to design the drivetrain 10′″ in FIG. 4 in a manner similar to that shown in FIG. 2, a differential 18′ being assigned to a driven axle 16′, which is arranged coaxially with the gearbox input shaft 24′ and coaxially with the drive motor 12.

In the drivetrain 10′″ gear changes from the gear 1 to the gear 2 are performed as has been described above. Gear changes from the gear 2 into the gear 3 are performed through overlapping actuation of the two powershift clutches 52′″, 112.

It is in general also possible to perform gear changes between the gears 1 and 3, the sequence then again being identical to the gear change between gear 1 and 2 as described above with reference to the other embodiments.

1. Step-variable transmission for a motor vehicle, having a gearbox inlet, which can be connected to a drive motor, and having a gearbox outlet, which can be connected to a driven axle of a motor vehicle, the step-variable transmission being designed for establishing at least a first gear and a further gear, power in the first gear being transmitted from the gearbox inlet to the gearbox outlet by way of a first clutch arrangement, power in the further gear being transmitted from the gearbox inlet to the gearbox outlet by way of a second clutch arrangement, the second clutch arrangement comprising a powershift clutch, and the first clutch arrangement comprising an overrunning clutch.

2. Step-variable transmission according to claim 1, wherein the overrunning clutch can be at least one of locked and/or decoupled from the gearbox outlet by means of an adjustable lockup clutch.

3. Step-variable transmission according to claim 2, wherein the lockup clutch is embodied as a dog clutch.

4. Step-variable transmission according to claim 2, wherein the lockup clutch is biased by means of a mechanical pretensioning device into an opened position in which the overrunning clutch is not locked.

5. Step-variable transmission according to claim 2, wherein the lockup clutch is biased into a closed position in which the overrunning clutch is coupled to the gearbox outlet.

6. Step-variable transmission according to claim 1, wherein the powershift clutch can be actuated by means of a first hydraulic actuator, which is directly connected to a pump, the rotational speed of which can be controlled for actuating the powershift clutch.

7. Step-variable transmission according to claim 6, wherein the pump is embodied as a bidirectional pump, the first connection of which is connected to the first hydraulic actuator and the second connection of which is connected to a second hydraulic actuator, which is assigned to the first clutch arrangement.

8. Step-variable transmission according to claim 7, wherein the second hydraulic actuator is designed for actuating a lockup clutch of the first clutch arrangement.

9. Step-variable transmission according to claim 6, wherein a first connection and a second connection of the pump are connected to a single pressure sensor by way of a shuttle valve.

10. Step-variable transmission according to claim 6, wherein yet another gear can be engaged by means of a third clutch arrangement, which comprises a second powershift clutch.

11. In a step-variable transmission for a motor vehicle, having a gearbox inlet, which can be connected to a drive motor, and having a gearbox outlet, which can be connected to a driven axle of a motor vehicle, the step-variable transmission being designed for establishing at least a first gear and a further gear, power in the first gear being transmitted from the gearbox inlet to the gearbox outlet by way of a first clutch arrangement, power in the further gear being transmitted from the gearbox inlet to the gearbox outlet by way of a second clutch arrangement, the second clutch arrangement comprising a powershift clutch, and the first clutch arrangement comprising an overrunning clutch,
a method for performing a traction upshift from the first gear into the second gear, comprising the steps of continuously closing the second clutch arrangement, in order to gradually take up the torque, the overrunning clutch transmitting the remainder of the torque at any given time, and performing a rotational speed adjustment on completion of the torque transfer.

12. In a step-variable transmission for a motor vehicle, having a gearbox inlet, which can be connected to a drive motor, and having a gearbox outlet, which can be connected to a driven axle of a motor vehicle, the step-variable transmission being designed for establishing at least a first gear and a further gear, power in the first gear being transmitted from the gearbox inlet to the gearbox outlet by way of a first clutch arrangement, power in the further gear being transmitted from the gearbox inlet to the gearbox outlet by way of a second clutch arrangement, the second clutch arrangement comprising a powershift clutch, and the first clutch arrangement comprising an overrunning clutch,
a method for performing a traction downshift from the second gear into the first gear, comprising the steps of bringing the second clutch arrangement first into a slipping state and then increasing the rotational speed on the gearbox inlet to a target speed of the first gear and reducing the slipping state, the torque transmitted by the second clutch arrangement then being reduced until the torque is transmitted by the overrunning clutch.

13. In a step-variable transmission for a motor vehicle, having a gearbox inlet, which can be connected to a drive motor, and having a gearbox outlet, which can be connected to a driven axle of a motor vehicle, the step-variable transmission being designed for establishing at least a first gear and a further gear, power in the first gear being transmitted from the gearbox inlet to the gearbox outlet by way of a first clutch arrangement, power in the further gear being transmitted from the gearbox inlet to the gearbox outlet by way of a second clutch arrangement, the second clutch arrangement comprising a powershift clutch, and the first clutch arrangement comprising an overrunning clutch,
a method for operating the step-variable transmission, comprising the step of operating the powershift clutch assigned to the second gear with slip in a reverse drive mode, so that a stress state in the step-variable transmission remains below a predefined threshold.
